(19) United States
(12) Patent Application Publication
(10) Pub. No.: US 2023/0297782 A1
(43) Pub. Date: Sep. 21, 2023

(54) STORAGE MEDIUM, OUTPUT METHOD, AND INFORMATION PROCESSING DEVICE

(71) Applicant: FUJITSU LIMITED, Kawasaki-shi (JP)

(72) Inventor: Hisanao AKIMA, Kawasaki (JP)

(73) Assignee: FUJITSU LIMITED, Kawasaki-shi (JP)

(21) Appl. No.: 17/870,824

(22) Filed: Jul. 22, 2022

(30) Foreign Application Priority Data
Nov. 18, 2021 (JP) 2021-187691

(51) Int. Cl. G06F 40/30; G06F 40/253; G06F 40/279; G06F 40/40

(52) U.S. Cl. CPC G06F 40/30; G06F 40/253; G06F 40/279; G06F 40/40; G06F 40/211

(57) ABSTRACT

A non-transitory computer-readable storage medium storing an output program that causes at least one computer to execute a process, the process includes analyzing first meaning representations of a target sentence to generate a first combination of subjects, verbs, and objects in the target sentence; searching for a second combination of subjects, verbs, and objects based on a knowledge base obtained by analyzing second meaning representations of input text, the knowledge base storing information that indicates a third combination of subjects, verbs, and objects in sentences, the third combination in the sentence having the cause-effect relationship with fourth combinations of subjects, verbs, and objects in each of sentences in the input text; and outputting the searched second combination.

### CROSS-REFERENCE TO RELATED APPLICATION

This application is based upon and claims the benefit of priority of the prior Japanese Patent Application No. 2021-187691, filed on Nov. 18, 2021, the entire contents of which are incorporated herein by reference.

### Field

The embodiments discussed herein are related to a storage medium, an output method, and an information processing device.

### BACKGROUND

Human beings gain the relationship between cause and effect, which is what kind of effect a certain action brings about, from experience and utilize the gained relationship in their daily lives. For example, by inferring what kind of effect will be produced by some behavior before taking the some behavior, it may be possible to make a decision to refrain from that behavior or rework the behavior plan. Such inference is a difficult task even for deep learning-based artificial intelligence (AI) that has achieved the performance beyond humans in tasks such as image recognition and language comprehension. The reason is that, when the relationship between cause and effect is a sort of common sense, the relationship is not explicitly organized into data, and when the relationship is obtained from a rare event that occurs infrequently or an experiment or development that does not allow many trials, the number of pieces of data is small, any case of which is incompatible with deep learning that relies on training using a large amount of data.

In order to accumulate the relationship between cause and effect as knowledge and utilize the accumulated knowledge for AI inference processing, gaining the relationship knowledge between cause and effect and exploiting the gained relationship will become problems. For such problems, an existing technique of recognizing text to perform syntax analysis, generating an event knowledge instance from a partial syntax and an event knowledge structure to construct an event knowledge base (database), and using the constructed event knowledge base (database) for inference is known.

Japanese National Publication of International Patent Application No. 2016-532942, U.S. Pat. Application Publication No. 2013/0212057, U.S. Patent Application Publication No. 2017/0337180, and U.S. Pat. Application Publication No. 2016/0224894 are disclosed as related art.

### SUMMARY

According to an aspect of the embodiments, a non-transitory computer-readable storage medium storing an output program that causes at least one computer to execute a process, the process includes analyzing first meaning representations of a target sentence to generate a first combination of subjects, verbs, and objects in the target sentence; searching for a second combination of subjects, verbs, and objects based on a knowledge base obtained by analyzing second meaning representations of input text, the knowledge base storing information that indicates a third combination of subjects, verbs, and objects in sentences, the third combination in the sentence having the cause-effect relationship with fourth combinations of subjects, verbs, and objects in each of sentences in the input text; and outputting the searched second combination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of an information processing device according to an embodiment;

FIG. 2 is an explanatory diagram explaining gaining of a knowledge base;

FIG. 3 is a flowchart illustrating an exemplary process relating to gaining of the knowledge base;

FIG. 4 is an explanatory diagram exemplifying the extraction of a cause-effect relationship by abstract meaning representation (AMR);

FIG. 5 is an explanatory diagram explaining an outline of backward inference of the information processing device according to the embodiment;

FIG. 6 is an explanatory diagram explaining an outline of forward inference of the information processing device according to the embodiment;

FIG. 7A and FIG. 7B are flowcharts illustrating an exemplary process relating to inference;

FIG. 8 is an explanatory diagram explaining examples of answers; and

FIG. 9 is an explanatory diagram explaining an example of a computer configuration.

### DESCRIPTION OF EMBODIMENTS

However, there is a disadvantage that the cause-effect relationship may not be sufficiently captured and the obtained inference result may be insufficient only by the syntax analysis, as in the above-mentioned existing technique. For example, it is difficult to make a forward inference of the effect brought about by a certain action or a backward inference of an action that leads to an objective.

In one aspect, it is aimed to provide an output program, output method, and information processing device capable of obtaining an inference result related to cause and effect.

An inference result related to cause and effect may be obtained.

Hereinafter, an output program, an output method, and an information processing device according to embodiments will be described with reference to the drawings. Constituents having the same functions in the embodiments are denoted with the same reference signs, and redundant description will be omitted. Note that the output program, the output method, and the information processing device to be described in the following embodiments are merely examples and do not limit the embodiments. In addition, the embodiments below may be appropriately combined with each other unless otherwise contradicted.

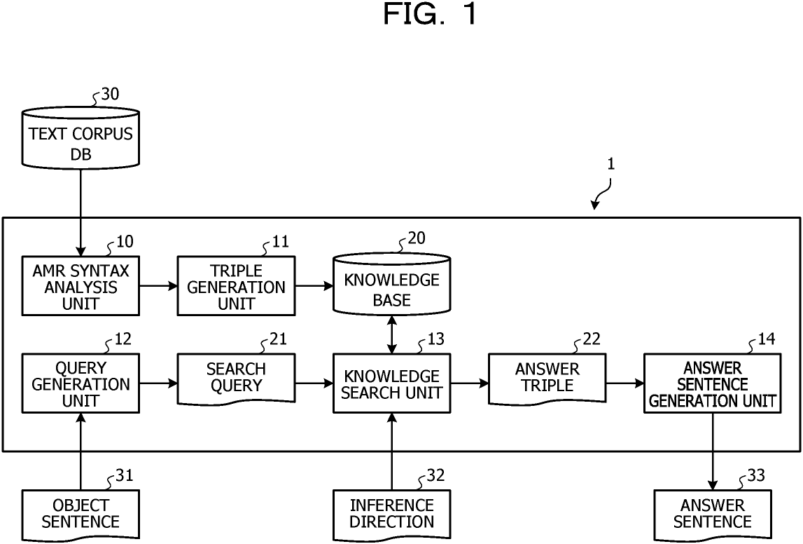

FIG. 1 is a block diagram illustrating an exemplary functional configuration of the information processing device according to an embodiment. As illustrated in FIG. 1, an information processing device 1 accepts an input of an object sentence 31 as an inference target sentence and an inference direction 32 indicating a forward inference or a backward inference in a cause-effect relationship.

Here, the forward inference in the cause-effect relationship refers to inferring the effect brought about by the content (action) expressed by the object sentence 31. In addition, the backward inference in the cause-effect relationship refers to inferring the objective (cause) of the content (action) expressed by the object sentence 31.

Then, the information processing device 1 refers to a knowledge base 20 generated from a text corpus database (DB) 30, works out an inference result corresponding to an answer triple 22 in the object sentence 31, and outputs an answer sentence 33 corresponding to this inference result. For example, a personal computer (PC) or the like may be applied as this information processing device 1.

For example, the information processing device 1 includes an AMR syntax analysis unit 10, a triple generation unit 11, a query generation unit 12, a knowledge search unit 13, and an answer sentence generation unit 14.

The AMR syntax analysis unit 10 is a processing unit that analyzes text written in natural language and converts the text into an abstract meaning representation (AMR). This AMR is obtained by representing the meaning of a sentence included in the text as a directed acyclic graph. The text-to-AMR conversion in the AMR syntax analysis unit 10 uses a known technique such as Sequence-to-Graph (StoG).

The AMR syntax analysis unit 10 converts the text acquired and input from the text corpus DB 30 into an abstract meaning representation (AMR) and outputs the conversion result to the triple generation unit 11. The text corpus DB 30 is a database that collects example sentences (text), and for example, Wikipedia or the like can be applied.

The triple generation unit 11 is a processing unit that generates a triple made up of the subject, verb, and object for the text input from the text corpus DB 30 in each sentence of the text on the basis of the conversion result of the AMR syntax analysis unit 10.

The conversion result of the AMR syntax analysis unit 10 includes a triple in which the binary relation (relation) of head and tail in each sentence of the text is written as (head, relation, tail). By assigning the verb (VB*) as relation, one with a smaller argument (ARG) number of the verb as head, and one with a larger ARG number of the verb as tail, the triple generation unit 11 obtains the triple of (subject, verb, object) in each sentence of the text.

In addition, for the triples generated from each sentence of the text on the basis of the conversion result of the AMR syntax analysis unit 10, the triple generation unit 11 acquires information indicating the association of the triples of sentences having a cause-effect relationship, on the basis of a label (cause) or the like indicating the semantic structure between the respective sentences included in the conversion result. Then, the triple generation unit 11 stores, in the knowledge base 20, the triples (subject, verb, object) generated from each sentence of the text and the information indicating the association between the triples of the sentences having a cause-effect relationship.

In this manner, the information processing device 1 gains, as the knowledge base 20, the triples (subject, verb, object) generated from each sentence of the text and the information indicating the association between the triples of the sentences having a cause-effect relationship, on the basis of the text input from the text corpus DB 30.

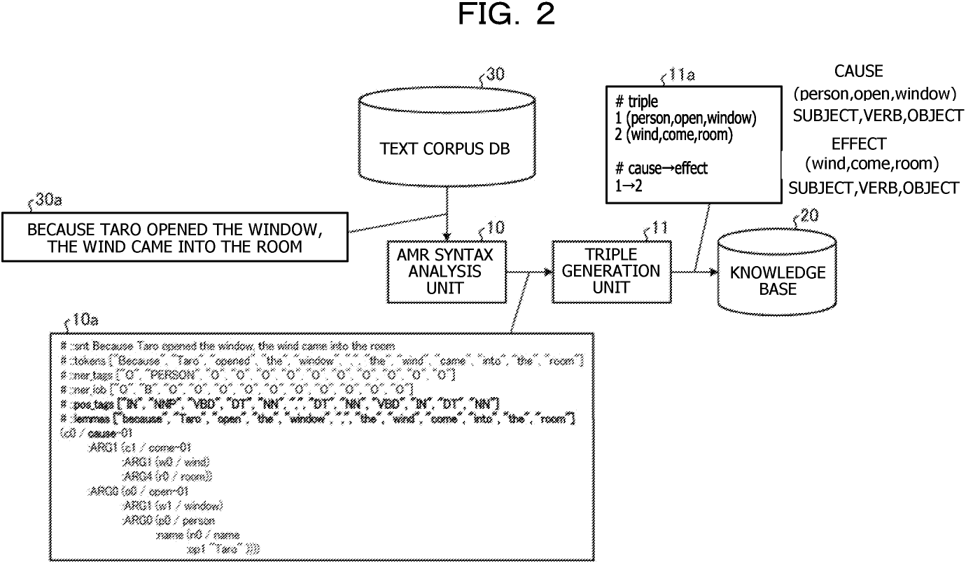

FIG. 2 is an explanatory diagram explaining gaining of the knowledge base 20. As illustrated in FIG. 2, the AMR syntax analysis unit 10 analyzes a text 30a acquired from the text corpus DB 30 and converts the analyzed text 30a into an abstract meaning representation (AMR) to obtain an AMR syntax analysis result 10a.

As an example, the text 30a acquired from the text corpus DB 30 is assumed as “Because Taro opened the window, the wind came into the room”. The AMR syntax analysis unit 10 obtains the AMR syntax analysis result 10a by analyzing the text 30a using a known technique such as StoG.

The AMR syntax analysis result 10a includes the parts of speech (pos_tags) and the base forms (lemmas) of words analyzed for each sentence included in the text 30a (for example, “Taro opened the window” and “the wind came into the room”). In addition, the AMR syntax analysis result 10a includes a label (cause) indicating the semantic structure of each sentence included in the text 30a, and a label (person) that abstracts the target. Furthermore, in the AMR syntax analysis result 10a, the order of the arguments in the binary relation is represented by the ARG + number.

On the basis of this AMR syntax analysis result 10a, the triple generation unit 11 generates a triple 11a from each sentence of the text 30a and stores the generated triple 11a in the knowledge base 20 together with the information indicating the association between the triples 11a of the sentences having a cause-effect relationship.

For example, the triple generation unit 11 generates a triple (subject, verb, object) of 1 (person, open, window) from the first sentence “Taro opened the window”. In addition, the triple generation unit 11 generates a triple (subject, verb, object) of 2 (wind, come, room) from the second sentence “the wind came into the room”. Furthermore, the triple generation unit 11 assigns one with a smaller ARG number in the label (cause) indicating the semantic structure as the cause and one with a larger ARG number as the effect to obtain the association between the triples 11a of the sentences having a cause-effect relationship (in the illustrated example, “1 -> 2” in #cause -> effect).

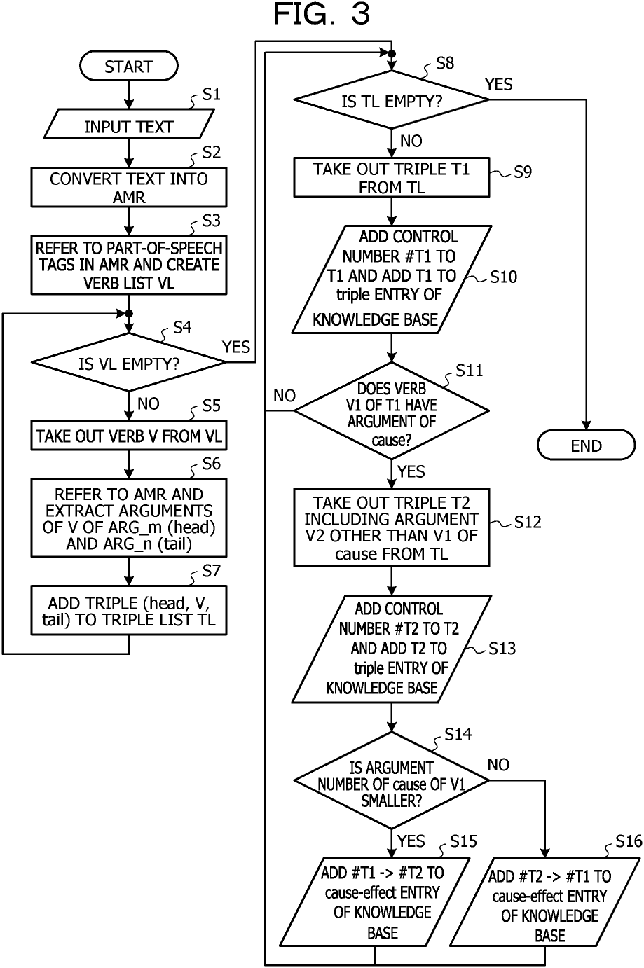

FIG. 3 is a flowchart illustrating an exemplary process relating to gaining of the knowledge base 20. As illustrated in FIG. 3, when the process is started, the AMR syntax analysis unit 10 accepts the input of the text 30a from the text corpus DB 30 (S1).

Then, the AMR syntax analysis unit 10 converts the accepted text 30a into an AMR (S2) and obtains the AMR syntax analysis result 10a.

Then, the triple generation unit 11 creates a verb list (VL) by referring to the part-of-speech tags in the AMR syntax analysis result 10a (S3). Then, the triple generation unit 11 determines whether or not the verb list VL is empty (S4) and, when the verb list VL is not empty (S4: No), performs the processes in S5 to S7.

For example, the triple generation unit 11 takes out a verb V from the verb list VL (S5). Then, the triple generation unit 11 extracts the arguments (ARG_m (head) and ARG_n (tail)) of the verb V with reference to the AMR syntax analysis result 10a (S6). For example, in S6, the triple generation unit 11 extracts the subject and the object with respect to the verb V.

Then, the triple generation unit 11 adds the triple (head, V, tail) to a triple list (TL) (S7) and returns the process to S4.

When the verb list VL is empty (S4: Yes), the triple generation unit 11 determines whether or not the triple list TL is empty (S8) and, when the triple list TL is not empty (S8: No), performs the processes in S9 to S16.

For example, the triple generation unit 11 takes out one triple T1 from the triple list TL (S9). Then, the triple generation unit 11 adds a control number #T1 to the taken-out triple T1 and adds the triple T1 with the control number #T1 to a triple entry of the knowledge base 20 (S10).

Then, the triple generation unit 11 refers to the AMR syntax analysis result 10a and determines whether or not the verb V1 of the triple T1 has the argument of cause (S11). When the argument is not of cause (S11: No), the triple generation unit 11 returns the process to S8.

When the argument is of cause (S11: Yes), the triple generation unit 11 takes out a triple T2 including an argument (verb V2) other than the verb V1 of cause from the triple list TL (S12).

Then, the triple generation unit 11 adds a control number #T2 to the taken-out triple T2 and adds the triple T2 with the control number #T2 to a triple entry of the knowledge base 20 (S13).

Then, the triple generation unit 11 determines whether or not the argument number of cause of the verb V1 is smaller than the argument number of cause of the verb V2 (S14). For example, the triple generation unit 11 determines which of cause and effect corresponds to the triples with the control numbers #T1 and #T2.

When the verb V1 has a smaller argument number of cause (S14: Yes), the triple generation unit 11 adds control number #T1 -> control number #T2 to a cause-effect entry of the knowledge base 20 (S15) and returns the process to S8. When the verb V1 does not have a smaller argument number of cause (S14: No), the triple generation unit 11 adds control number #T2 -> control number #T1 to the cause-effect entry of the knowledge base 20 (S16) and returns the process to S8.

When the triple list TL is empty (S8: Yes), the triple generation unit 11 ends the process because all the information based on the text 30a has been stored in the knowledge base 20.

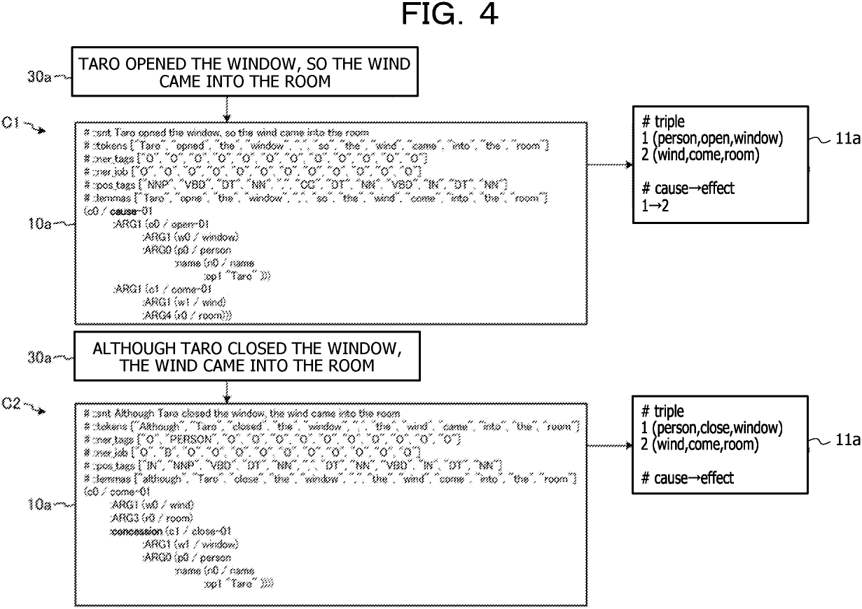

FIG. 4 is an explanatory diagram exemplifying the extraction of the cause-effect relationship by AMR. As illustrated in FIG. 4, in a case C1, the AMR syntax analysis result 10a analyzed by the AMR syntax analysis unit 10 is assumed as “Taro opened the window, so the wind came into the room”. In addition, in a case C2, the AMR syntax analysis result 10a analyzed by the AMR syntax analysis unit 10 is assumed as “Although Taro closed the window, the wind came into the room”.

As for the case C1, a triple (person, open, window) corresponding to “Taro opened the window” is given the control number #T1, and a triple (wind, come, room) corresponding to “the wind came into the room” is given the control number #T2. Note that, even if a representation with “so” is used, the cause label is attached in the AMR syntax analysis result 10a. In this case, the triple generation unit 11 considers that there is a cause-effect relationship in the order of output because the ARG numbers of cause both have 1, and assigns the cause-effect entry in the knowledge base 20 as “1 -> 2”.

With this knowledge base 20, for the triple (person, open, window) and the triple (wind, come, room), a relationship that the triple (person, open, window) is assigned as a cause and the triple (wind, come, room) is assigned as an effect may be understood.

As for the case C2, a triple (person, close, window) corresponding to “Taro closed the window” is given the control number #T1, and a triple (wind, come, room) corresponding to “the wind came into the room” is given the control number #T2. In this case, since the cause label is not attached to the AMR syntax analysis result 10a, the triple generation unit 11 assumes that there is no cause-effect entry in the knowledge base 20.

With this knowledge base 20, it may be understood that there is no cause-effect relationship between the two triples, namely, the triple (person, close, window) and the triple (wind, come, room).

Returning to FIG. 1, the query generation unit 12 is a processing unit that analyzes the meaning representation of the object sentence 31 as an inference target sentence and generates a triple made up of the subject, verb, and object in this inference target sentence, as a search query 21.

For example, the query generation unit 12 analyzes the meaning representation of the object sentence 31 written in natural language and converts the analyzed meaning representation into an abstract meaning representation (AMR), similarly to the AMR syntax analysis unit 10. Then, the query generation unit 12 generates a triple made up of the subject, verb, and object in the object sentence 31 as the search query 21 on the basis of the conversion result to the AMR, as in the triple generation unit 11.

The knowledge search unit 13 is a processing unit that searches the knowledge base 20 for the answer triple 22 having a cause-effect relationship with the triple (search query 21) of the object sentence 31 and outputs the answer triple 22 found by the search. For example, the knowledge search unit 13 searches the knowledge base 20 for a triple that matches (exactly matches or partially matches) with the search query 21. Then, the knowledge search unit 13 identifies and outputs the answer triple 22 having a cause-effect relationship, for the matched triple by referring to the cause-effect entries of the knowledge base 20.

For example, when the forward inference is designated as the inference direction 32, the knowledge search unit 13 assigns the matched triple as a cause and identifies the answer triple 22 corresponding to the effect with respect to that cause by tracing the cause-effect entry in a forward direction (in the orientation of “->”). In addition, when the backward inference is designated as the inference direction 32, the knowledge search unit 13 assigns the matched triple as an effect and identifies the answer triple 22 corresponding to the cause with respect to that effect by tracing the cause-effect entry in a reverse direction (in the opposite orientation of “->”).

The answer sentence generation unit 14 is a processing unit that generates and outputs the answer sentence 33 in which the subject, verb, and object are appropriately arranged on the basis of the answer triple 22 output by the knowledge search unit 13. For example, by using a known document generation technique such as reverse conversion of AMR into a document as an example, the answer sentence generation unit 14 generates the answer sentence 33 on the basis of the subject, verb, and object included in the answer triple 22.

The answer sentence generation unit 14 outputs the generated answer sentence 33 to a user, for example, by displaying output on a display, outputting a file, or the like.

Note that, in the present embodiment, the configuration in which the answer sentence 33 is generated and output from the answer triple 22 output by the knowledge search unit 13 is exemplified, but the answer triple 22 may be output as it is. In this case, the user will deduce the content from the subject, verb, and object included in the answer triple 22.

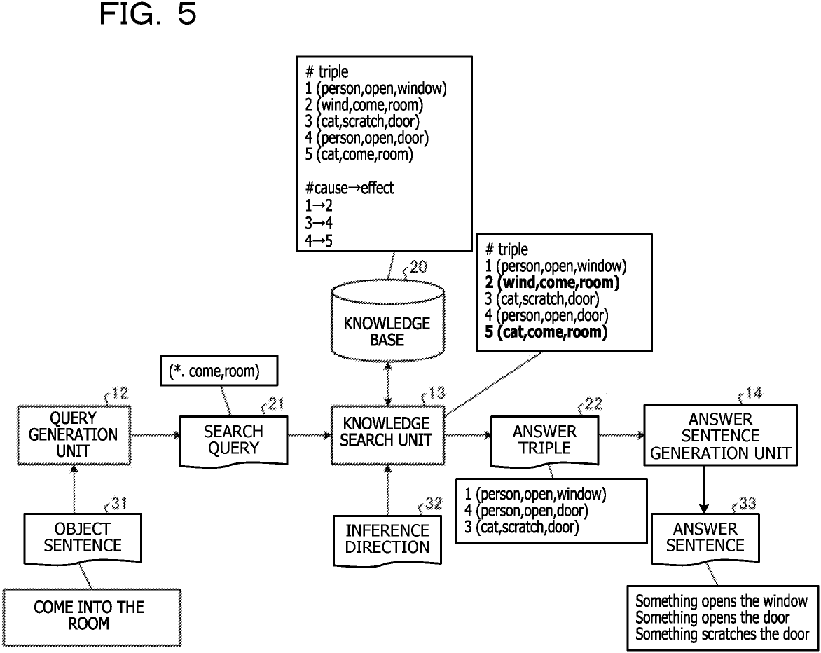

FIG. 5 is an explanatory diagram explaining an outline of the backward inference of the information processing device 1 according to the embodiment. As illustrated in FIG. 5, it is assumed that “come into the room” is input to the query generation unit 12 as the object sentence 31. In addition, it is assumed that the backward inference direction 32 is input to the knowledge search unit 13.

The query generation unit 12 generates the search query 21 (*, come, room) corresponding to this object sentence 31 by analyzing the object sentence 31. Here, since the subject part of the object sentence 31 is unknown, the query generation unit 12 replaces the subject part with “* (don’t care)”.

Then, the knowledge search unit 13 refers to the knowledge base 20 and obtains 2 (wind, come, room) and 5 (cat, come, room) that match the search query 21 (*, come, room).

Then, the knowledge search unit 13 identifies the answer triple 22 by tracing the cause-effect entries of the knowledge base 20 in the reverse direction starting from the matched 2 (wind, come, room) and 5 (cat, come, room).

For example, the knowledge search unit 13 traces “1 -> 2” in the cause-effect entry in the reverse direction to identify 1 (person, open, window) starting from 2 (wind, come, room). In addition, the knowledge search unit 13 traces “4 -> 5” and “3 -> 4” in the cause-effect entries in the reverse direction to specify 4 (person, open, door) and 3 (cat, scratch, door) starting from 5 (cat, come, room). Note that, for a triple such as 2 (wind, come, room), the first number is assigned as “#2” or the like and the inside of the triple is omitted in some cases.

Then, the answer sentence generation unit 14 generates the answer sentence 33 on the basis of the answer triple 22 identified by the knowledge search unit 13. For example, the answer sentence generation unit 14 replaces the subject part of each of #1, #4, and #3 included in the answer triple 22 with something.

Then, the answer sentence generation unit 14 converts the triples (#1, #4, #3) in which the subject parts have been replaced with something into an AMR (verb: ARG0 something: ARG1 obj). Then, by using a known document conversion technique such as Graph-to-Sequence (GtoS), the answer sentence generation unit 14 converts the AMR converted from the triples (#1, #4, #3) into a document to obtain the answer sentences 33.

As an example, the answer sentence generation unit 14 obtains “Something opens the window” from 1 (person, open, window). In addition, the answer sentence generation unit 14 obtains “Something opens the door” from 4 (person, open, door). Furthermore, the answer sentence generation unit 14 obtains “Something scratches the door” from 3 (cat, scratch, door).

Such answer sentences 33 may allow the user to understand that, for example, “Something scratches the door” is possible as an action intended to “come into the room” in the object sentence 31.

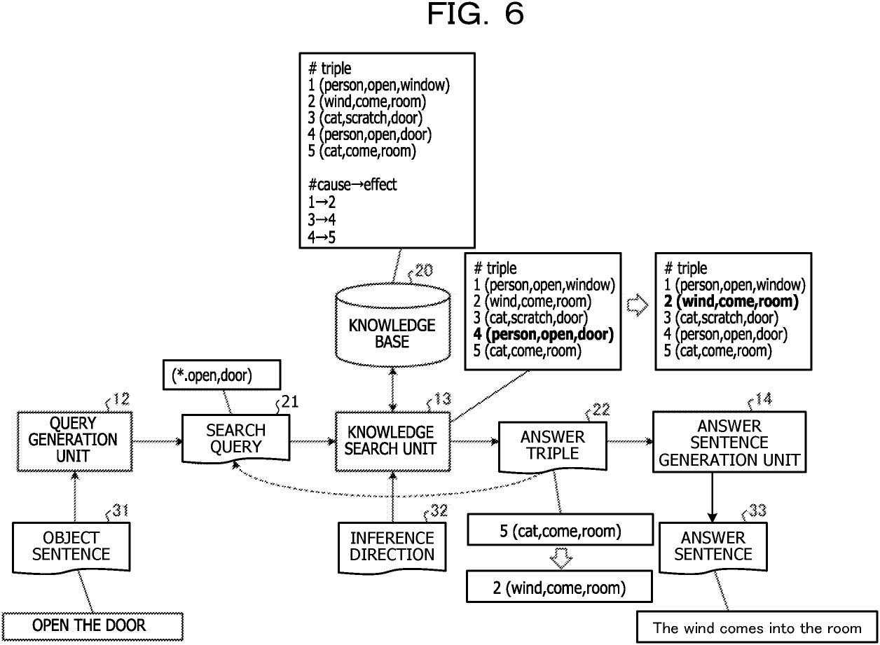

FIG. 6 is an explanatory diagram explaining an outline of the forward inference of the information processing device 1 according to the embodiment. As illustrated in FIG. 6, it is assumed that “open the door” is input to the query generation unit 12 as the object sentence 31. In addition, it is assumed that the forward inference direction 32 is input to the knowledge search unit 13.

The query generation unit 12 generates the search query 21 (*, open, door) corresponding to this object sentence 31 by analyzing the object sentence 31. Here, since the subject part of the object sentence 31 is unknown, the query generation unit 12 replaces the subject part with “* (don’t care)”.

Then, the knowledge search unit 13 refers to the knowledge base 20 and obtains 4 (person, open, door) that matches the search query 21 (*, open, door).

Then, the knowledge search unit 13 identifies the inference direction 32 by tracing the cause-effect entries of the knowledge base 20 in the forward direction starting from the matched 4 (person, open, door).

For example, the knowledge search unit 13 traces “4 -> 5” in the cause-effect entry in the forward direction to identify 5 (cat, come, room) starting from 4 (person, open, door).

Here, the knowledge search unit 13 may replace the subject part of 5 (cat, come, room) with “* (don’t care)” to make a new search query 21 and research the knowledge base 20 for the new search query 21. For example, when the result obtained by the search is a triple that does not include “something” or “person” such as 5 (cat, come, room), the knowledge search unit 13 makes a re-exploration with the subject part of the triple as “* (don’t care)” to broadly explore possibilities. The user may appropriately adjust this re-exploration by setting or the like, such as leaving the result as it is without re-exploration.

The knowledge search unit 13 identifies 5 (window, come, room) obtained by the re-exploration as the answer triple 22. Then, the answer sentence generation unit 14 generates the answer sentence 33 on the basis of the answer triple 22 identified by the knowledge search unit 13. For example, the answer sentence generation unit 14 obtains the answer sentence 33 that states “The wind comes into the room”, by converting #5 included in the answer triple 22 into an AMR and using GtoS or the like.

Such an answer sentence 33 may allow the user to understand that “The wind comes into the room” is possible as an effect with respect to “open the door” in the object sentence 31.

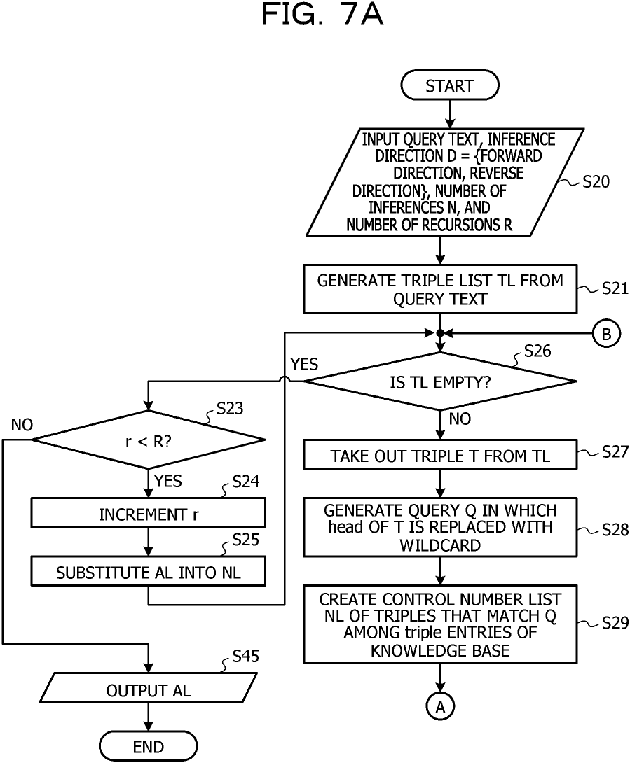

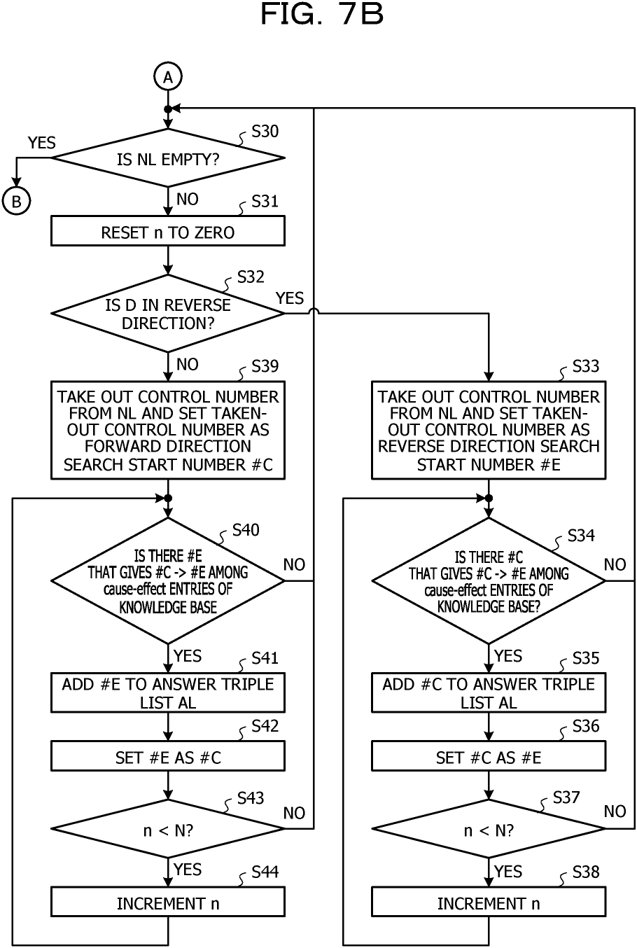

FIG. 7A and FIG. 7B are flowcharts illustrating an exemplary process relating to the inference. As illustrated in FIG. 7A and FIG. 7B, when the process is started, the query generation unit 12 accepts the input of a query text (object sentence 31). In addition, the knowledge search unit 13 accepts an input of the inference direction 32 (D = {forward direction, reverse direction}). Note that the forward direction corresponds to the forward inference, and the reverse direction corresponds to the backward inference separately. In addition, the knowledge search unit 13 also accepts an input of setting information regarding processing, such as the number of inferences N and the number of recursions R (S20).

Then, the query generation unit 12 generates the triple list TL from the accepted query text (S21). Then, the knowledge search unit 13 determines whether or not the triple list TL is empty (S26) and, when the triple list TL is not empty (S26: No), repeats the processes in S26 to S44.

For example, the knowledge search unit 13 takes out a triple T from the triple list TL (S27) and generates a query Q in which head of T is replaced with a wildcard (*) (S28). Then, the knowledge search unit 13 creates a control number list NL of triples that match the query Q among the triple entries of the knowledge base 20 (S29).

Then, the knowledge search unit 13 determines whether or not the control number list NL is empty (S30) and, when the control number list NL is not empty (S30: No), proceeds to the process in S31 and subsequent processes. Note that, when the control number list NL is empty (S30: Yes), the knowledge search unit 13 returns the process to S26.

In S31, the knowledge search unit 13 resets n of a processing counter to zero (S31) and determines whether or not the object sentence 31 (D) is in the reverse direction (backward inference) (S32).

When D is in the reverse direction (S32: Yes), the knowledge search unit 13 takes out a control number from the control number list NL and sets the taken-out control number as a reverse direction search start number #E (S33).

Then, the knowledge search unit 13 determines whether or not there is #C that gives #C -> #E among the cause-effect entries of the knowledge base 20 (S34). When there is no such #C (S34: No), the knowledge search unit 13 returns the process to S30.

When there is such #C (S34: Yes), the knowledge search unit 13 adds #C to an answer triple list AL (S35) and sets #C as #E (S36).

Then, the knowledge search unit 13 determines whether or not the counter n < the number of inferences N holds (S37) and, when the determination is affirmative (S37: Yes), increments the counter n to return the process to S34. When the determination is negative (S37: No), the knowledge search unit 13 returns the process to S30.

When D is in the forward direction in S32 (S32: No), the knowledge search unit 13 takes out a control number from the control number list NL and sets the taken-out control number as a forward direction search start number #C (S39).

Then, the knowledge search unit 13 determines whether or not there is #E that gives #C -> #E among the cause-effect entries of the knowledge base 20 (S40). When there is no such #E (S40: No), the knowledge search unit 13 returns the process to S30.

When there is such #E (S40: Yes), the knowledge search unit 13 adds #E to the answer triple list AL (S41) and sets #E as #C (S42).

Then, the knowledge search unit 13 determines whether or not the counter n < the number of inferences N holds (S43) and, when the determination is affirmative (S43: Yes), increments the counter n to return the process to S40. When the determination is negative (S43: No), the knowledge search unit 13 returns the process to S30.

When the triple list TL is empty in S26 (S26: Yes), the knowledge search unit 13 determines whether or not a count number r at when recursion is made < the number of recursions R holds (S23). When the determination is affirmative in S23 (S23: Yes), the knowledge search unit 13 increments the count number r (S24). Then, the knowledge search unit 13 substitutes the answer triple list AL into the control number list NL (S25) and returns the process to S26.

When the determination is negative in S23 (S23: No), the knowledge search unit 13 outputs the answer triple list AL to the answer sentence generation unit 14 (S45) and ends the process.

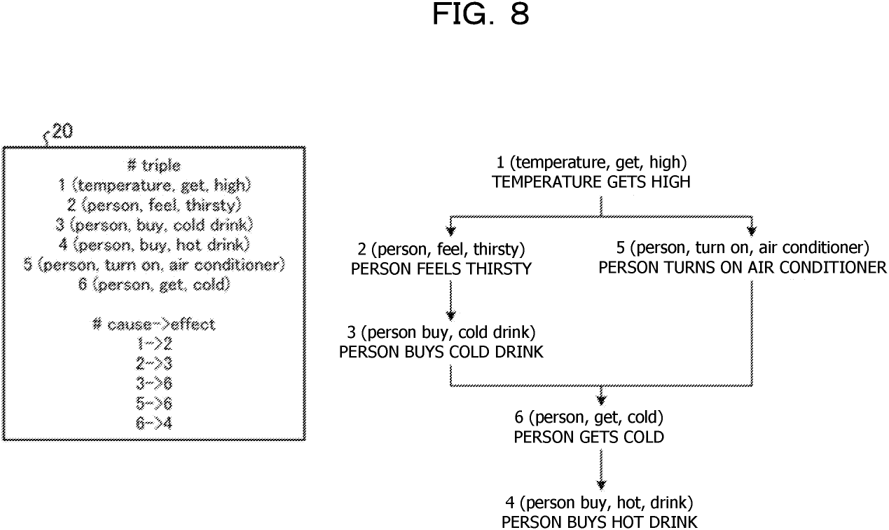

FIG. 8 is an explanatory diagram explaining examples of answers. As illustrated in FIG. 8, in the knowledge base 20, the cause-effect relationships between respective sentences are indicated in the cause-effect entries.

As an example, when the user wants to know what kind of products will sell on a hot day, the user inputs the object sentence 31 that states “the temperature gets high” and the forward inference direction 32. When the inference stage (number of inferences N) has one stage, the information processing device 1 outputs {a person feels thirsty, a person turns on the air conditioner} as the answer sentences 33 by referring to the knowledge base 20. In addition, the information processing device 1 outputs {a person buys a cold drink, a person gets cold} when the inference stage (number of inferences N) has two stages and outputs {a person gets cold, a person buys a hot drink} when the inference stage (number of inferences N) has three stages, as the answer sentences 33. This allows the user to understand that there is likely to be a demand for hot drinks even on hot days.

In addition, as an example, when the user wants to avoid getting cold, the user inputs the object sentence 31 that states “get cold” and the backward inference direction 32. When the inference stage (number of inferences N) has one stage, the information processing device 1 outputs {a person turns on the air conditioner, a person buys a cold drink} as the answer sentences 33 by referring to the knowledge base 20. In addition, the information processing device 1 outputs {a person feels thirsty, the temperature gets high} when the inference stage (number of inferences N) has two stages and outputs {the temperature gets high} when the inference stage (number of inferences N) has three stages, as the answer sentences 33. This allows the user to understand that the answers are “do not turn on the air conditioner” and “do not buy a cold drink”, which are the opposite of the answer sentences 33, because it is only desired to avoid a behavior that leads to “get cold”.

As described above, the information processing device 1 analyzes the meaning representation of the text 30a input from the text corpus DB 30 and stores, in the knowledge base 20, the triple made up of the subject, verb, and object of each sentence included in the text 30a, and the information indicating the association between the triples of the sentences having a cause-effect relationship, based on the analyzed meaning representation. The information processing device 1 analyzes the meaning representation of the object sentence 31 as an inference target sentence and generates a triple made up of the subject, verb, and object in this inference target sentence. The information processing device 1 searches the knowledge base 20 for the answer triple 22 having a cause-effect relationship with the triple of the inference target sentence and outputs the answer triple 22 found by the search.

In this manner, by using the knowledge base 20 obtained by accurately capturing and accumulating the cause-effect relationship by analyzing the meaning representation of the text 30a in the text corpus DB 30, the information processing device 1 may obtain the triple as a result of inference related to cause and effect on the inference target sentence.

In addition, when the inference direction 32 for the effect brought about by the action indicated by the inference target sentence is designated (forward inference), the information processing device 1 searches for the answer triple 22 having the relationship of effect with the triple of the inference target sentence. This allows the information processing device 1 to obtain the inference result of the forward inference that has the relationship of effect with the triple of the inference target sentence.

In addition, when the inference direction 32 for the cause leading to the objective of the action indicated by the inference target sentence is designated (backward inference), the information processing device 1 search for the answer triple 22 having the relationship of cause with the triple of the inference target sentence. This allows the information processing device 1 to obtain the inference result of the backward inference that has the relationship of cause with the triple of the inference target sentence.

Furthermore, the information processing device 1 generates the answer sentence 33 corresponding to the inference target sentence, based on the answer triple 22 found by the search. This allows the information processing device 1 to obtain the answer sentence 33 as an inference result corresponding to the inference target sentence.

Note that each of the illustrated components in each of the devices does not necessarily have to be physically configured as illustrated in the drawings. For example, specific modes of distribution and integration of the individual devices are not restricted to those illustrated, and all or some of the devices may be configured by being functionally or physically distributed and integrated in any unit depending on various loads, usage status, and the like.

In addition, various processing functions of the AMR syntax analysis unit 10, the triple generation unit 11, the query generation unit 12, the knowledge search unit 13, and the answer sentence generation unit 14 in the information processing device 1 may be entirely or optionally partially executed on a central processing unit (CPU) (or a microcomputer such as a microprocessor unit (MPU) or a micro controller unit (MCU)). In addition, it is needless to say that all or any part of various processing functions may be executed on a program analyzed and executed by a CPU (or a microcomputer such as an MPU or an MCU) or in hardware by wired logic. Furthermore, various processing functions performed by the information processing device 1 may be executed by a plurality of computers in cooperation through cloud computing.

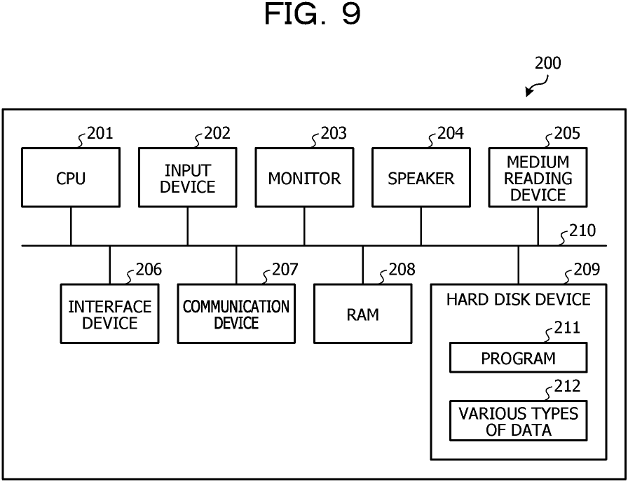

Meanwhile, various processes described in the above embodiments may be implemented by executing a program prepared in advance on a computer. Thus, hereinafter, an example of a computer configuration (hardware) that executes a program having functions similar to the functions of the above embodiments will be described. FIG. 9 is an explanatory diagram explaining an example of a computer configuration.

As illustrated in FIG. 9, a computer 200 includes a CPU 201 that executes various arithmetic processes, an input device 202 that accepts data input, a monitor 203, and a speaker 204. In addition, the computer 200 includes a medium reading device 205 that reads a program and the like from a storage medium, an interface device 206 for connecting to various devices, and a communication device 207 for connecting to and communicating with an external device in a wired or wireless manner. Furthermore, the information processing device 1 includes a random access memory (RAM) 208 that temporarily stores various types of information, and a hard disk device 209. In addition, each of the units (201 to 209) in the computer 200 is connected to a bus 210.

The hard disk device 209 stores a program 211 for executing various processes of the functional configuration described in the embodiments above (for example, the AMR syntax analysis unit 10, the triple generation unit 11, the query generation unit 12, the knowledge search unit 13, and the answer sentence generation unit 14). Furthermore, the hard disk device 209 stores various types of data 212 that the program 211 refers to. The input device 202 accepts, for example, an input of operation information from an operator. The monitor 203 displays, for example, various screens operated by the operator. For example, the interface device 206 is connected to a printing device or the like. The communication device 207 is connected to a communication network such as a local area network (LAN) and exchanges various types of information with an external device via the communication network.

By reading the program 211 stored in the hard disk device 209 and loading the program 211 into the RAM 208 to execute the program 211 on the RAM 208, the CPU 201 performs various processes related to the functional configuration described above (for example, the AMR syntax analysis unit 10, the triple generation unit 11, the query generation unit 12, the knowledge search unit 13, and the answer sentence generation unit 14). Note that the program 211 does not have to be prestored in the hard disk device 209. For example, the program 211 stored in a storage medium readable by the computer 200 may be read and executed. For example, the storage medium readable by the computer 200 corresponds to a portable recording medium such as a compact disc read only memory (CD-ROM), a digital versatile disc (DVD), or a universal serial bus (USB) memory, a semiconductor memory such as a flash memory, a hard disk drive, or the like. In addition, this program 211 may be prestored in a device connected to a public line, the Internet, a LAN, or the like, and the computer 200 may read the program 211 from the device and execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an output program that causes at least one computer to execute a process, the process comprising:
analyzing first meaning representations of a target sentence to generate a first combination of subjects, verbs, and objects in the target sentence;
searching for a second combination of subjects, verbs, and objects based on a knowledge base obtained by analyzing second meaning representations of input text, the knowledge base storing information that indicates a third combination of subjects, verbs, and objects in sentences, the third combination in the sentence having the cause-effect relationship with fourth combinations of subjects, verbs, and objects in each of sentences in the input text; and
outputting the searched second combination.

2. The non-transitory computer-readable storage medium according to claim 1, wherein
the searching includes searching for combination that has an effect relationship when the first combination is cause, as the second combination, when an inference direction for effect brought about by an action indicated by the target sentence is designated.

3. The non-transitory computer-readable storage medium according to claim 1, wherein
the searching includes searching for combination that has an effect relationship when the first combination is cause, as the second combination, when an inference direction for cause that leads to an objective of an action indicated by the target sentence is designated.

4. The non-transitory computer-readable storage medium according to claim 1, the process further comprising
generating an answer sentence that corresponds to the target sentence based on the second combination.

5. An output method for a computer to execute a process comprising:
analyzing first meaning representations of a target sentence to generate a first combination of subjects, verbs, and objects in the target sentence;
searching for a second combination of subjects, verbs, and objects based on a knowledge base obtained by analyzing second meaning representations of input text, the knowledge base storing information that indicates a third combination of subjects, verbs, and objects in sentences, the third combination in the sentence having the cause-effect relationship with fourth combinations of subjects, verbs, and objects in each of sentences in the input text; and
outputting the searched second combination.

6. The output method according to claim 5, wherein
the searching includes searching for combination that has an effect relationship when the first combination is cause, as the second combination, when an inference direction for effect brought about by an action indicated by the target sentence is designated.

7. The output method according to claim 5, wherein
the searching includes searching for combination that has an effect relationship when the first combination is cause, as the second combination, when an inference direction for cause that leads to an objective of an action indicated by the target sentence is designated.

8. The output method according to claim 5, wherein the process further comprising
generating an answer sentence that corresponds to the target sentence based on the second combination.

9. An information processing device comprising:
one or more memories; and
one or more processors coupled to the one or more memories and the one or more processors configured to:
analyze first meaning representations of a target sentence to generate a first combination of subjects, verbs, and objects in the target sentence,
search for a second combination of subjects, verbs, and objects based on a knowledge base obtained by analyzing second meaning representations of input text, the knowledge base storing information that indicates a third combination of subjects, verbs, and objects in sentences, the third combination in the sentence having the cause-effect relationship with fourth combinations of subjects, verbs, and objects in each of sentences in the input text, and
output the searched second combination.

10. The information processing device according to claim 9, wherein the one or more processors are further configured to
search for combination that has an effect relationship when the first combination is cause, as the second combination, when an inference direction for effect brought about by an action indicated by the target sentence is designated.

11. The information processing device according to claim 9, wherein the one or more processors are further configured to
search for combination that has an effect relationship when the first combination is cause, as the second combination, when an inference direction for cause that leads to an objective of an action indicated by the target sentence is designated.

12. The information processing device according to claim 9, wherein the one or more processors are further configured to
generate an answer sentence that corresponds to the target sentence based on the second combination.
